(19) United States
(12) Patent Application Publication
(10) Pub. No.: US 2011/0271228 A1
(43) Pub. Date: Nov. 3, 2011

(54) Systems, Methods, and Computer Program Products Providing an Article Selection Structure

(75) Inventors: Benjamin B. Bederson, Chevy Chase, MD (US); John SanGiovanni, Seattle, WA (US)

(73) Assignee: Zumobi, Inc., Seattle, WA (US)

(21) Appl. No.: 12/772,752

(22) Filed: May 3, 2010

(51) Int. Cl. G06F 3/048

(52) U.S. Cl. 715/803

(57) ABSTRACT

A computer program product having a computer readable medium tangibly recording computer program logic, the computer program product including code to provide a web access program different from a general-purpose web browser, with the web access program including code to render upon a display screen a Graphical User Interface (GUI) that has a first side for viewing content, code to render a second side in the GUI, the second side including a list of articles, the second side further including a plurality of selectable features allowing user input to access one or more of the articles, and code to place accessed articles in the first side.

### CROSS-REFERENCE TO RELATED APPLICATIONS

The present application is related to U.S. patent application Ser. No. ______ (Attorney Docket No. ZMBP.P0015US), filed concurrently herewith and entitled, “SYSTEMS, METHODS, AND COMPUTER PROGRAM PRODUCTS PROVIDING AN INTEGRATED USER INTERFACE FOR READING CONTENT,” which is incorporated by reference herein in its entirety.

### TECHNICAL FIELD

The present disclosure relates, in general, to user interfaces and, more specifically, for user interfaces for selecting articles.

### BACKGROUND

FIG. 1 is an illustration of a conventional web browser 100. The web browser 100 has pull-down menus 102, forward and back navigation buttons 104, an entry field 106 for a Uniform Resource Locator (URL), bookmarklets 108, and tabs 110 as are well known in the art. The functional features for navigation, such as items 102-110 are placed in the control portion, which is separate from the viewing portion 120. Viewing portion 120 is where content is rendered for the user. For example, text, pictures, videos, games, and the like are rendered in viewing portion 120.

Web-based content such as blogs or magazines are typically accessed using a web browser the same as or similar to that shown in FIG. 1. One use scenario is that when a user goes to a blog or feed, the user is presented with a list of articles. If the user only comes to visit that site infrequently there may be many new articles that have been published since the user last visited. Roughly speaking, there are a few ways that the user may access the long list. One modality includes the user being presented with a list of titles and abstracts. The user gets a long list of the titles and abstracts and clicks on the ones of interest. The user serially clicks, reads, and goes back to the list to find and click the next article of interest.

In another modality the user goes through the list of titles and abstracts and selects which ones the user wants to read and then later goes back to read the selected articles. The second modality is usually performed using tabs 110 in web browser 100, where the user right clicks on a link and selects an “open in tab” option that opens the selected article in a new tab. So as the user goes through the list and selects, e.g., four articles, the user creates four tabs on web browser 100, and the user can select the articles using the different tabs.

In one specific example of the second use modality, a user clicks on one of the bookmarklets 108 to get a list 112 of articles through an Really Simple Syndication (RSS) feed. List 112 is shown in FIG. 2, which is another illustration of web browser 100. The user can select articles in list 112, and each selected article is opened up in its own tab. Google Reader™ is a more advanced RSS and Atom reader and works in a similar manner to that shown in FIG. 2. However, whether a user opens and reads articles one at a time or opens up many articles at once, these two use modalities tend to create an inconvenient navigation burden on a user and may create a screen that is too cluttered for easy use.

In an third and related use modality, a user employs a service that saves selected web pages for reading later. Examples of such services include Instapaper™, Read It Later™, Laterloop™, and Later This™. Generally speaking, such services may provide a bookmarklet that a user can click on when a user has a tab opened to a web page that the user would like to visit later (perhaps offline). The service then creates a list of the web pages to be visited later. The user may access the list either on the same computer or on a different computer, and even on an application on a handheld device. However, in such services, the user must select a page to be viewed later and then open the page—at least a two step process. Viewer selection of articles in any of the three use modalities above is not well-supported by tabbed browsing, alone, or the services that allow a user to select and read an article later.

### BRIEF SUMMARY

Various embodiments are directed to systems, methods, and computer program products that provide an interface wherein one side provides a list of articles and selection mechanisms and another side includes the articles that are selected. The interface may be in the content-viewing portion of a general-purpose web browser or part of an application that is not a general-purpose web browser.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIGS. 1 and 2 show a conventional web browser;

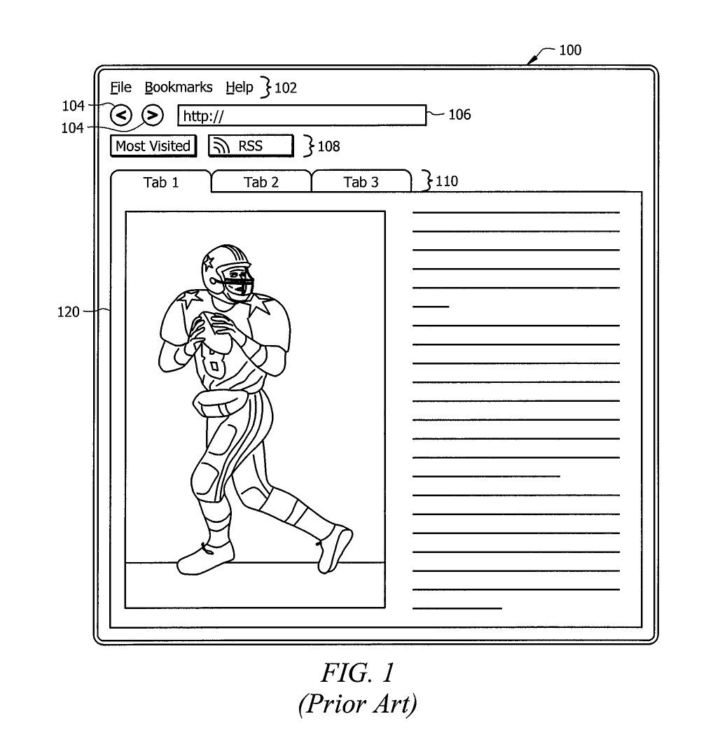

FIG. 3 is an illustration of an exemplary Graphical User Interface (GUI) adapted according to one embodiment of the invention;

FIG. 4 is an illustration of a GUI, adapted according to one embodiment of the invention;

FIG. 5 is a conceptual illustration of an example GUI adapted according to one embodiment of the invention;

FIG. 6 is an illustration of an exemplary method adapted according to one embodiment of the invention;

FIG. 7 is an illustration of an exemplary system adapted according to one embodiment of the invention; and

FIG. 8 illustrates an example computer system adapted according to one embodiment of the present invention.

### DETAILED DESCRIPTION

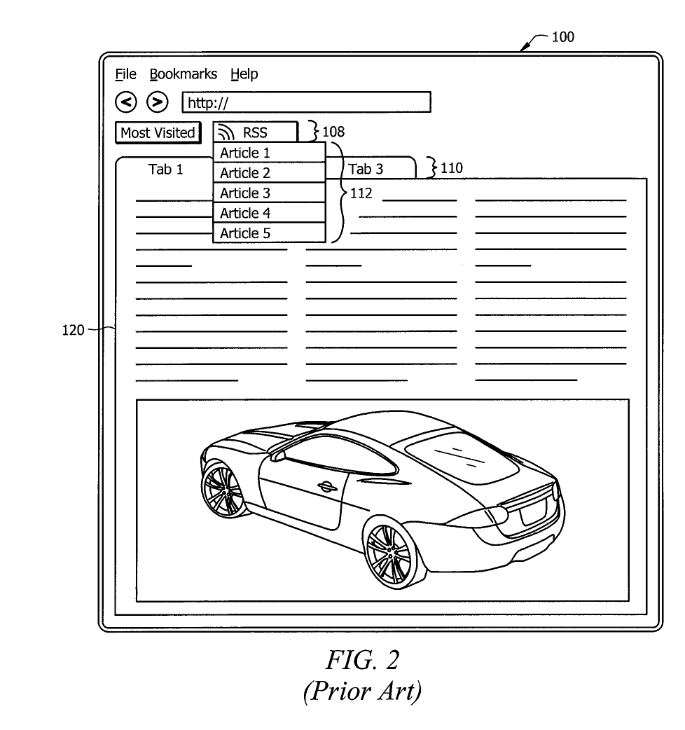

FIG. 3 is an illustration of exemplary Graphical User Interface (GUI) 300 adapted according to one embodiment of the invention. GUI 300 is shown upon a tablet computer 350 (e.g., an iPad™, available from Apple) that has a touchscreen surface where a user interacts with GUI 300 through hand gestures upon the screen. Of note in FIG. 3 is that GUI 300 exists in an application for the tablet computer 350 and is separate from any general-purpose web browser that may be supported by tablet computer 350. Various embodiments of the invention may be implemented as web page functionality displayed in a browser, a browser plug-in, a stand-alone application, or any other way now known or later developed. Furthermore, while the example of FIG. 3 is shown in a tablet computer, various embodiments may be used in other types of processor-based device, such as laptop computers, desktop computers, and portable devices such as phones.

GUI 300 includes column 330, integrated in GUI 300 with columns 310, 320. The items in column 330 correspond to available articles. A user can select one, some, all, or none of the available articles to be viewed. Upon selection, an article is divided into text and graphics and distributed in columns 310, 320. Column 330 includes indicators showing which of the articles have been selected and are available for viewing in columns 310, 320. Specifically, column 330 includes circles that when filled in, colored, or otherwise visually marked, indicate that a corresponding article has been selected. In FIG. 3, circles 301-304 are visually marked to indicate having been selected.

Column 330 also includes tabs 331-334, which each correspond to a topic and act as a filter, thus reducing the list of article summaries displayed in column 330. At any given time, there may be more articles selected than display space available, so columns 310, 320 are scrollable. When a tab is selected, the corresponding article is brought into view in columns 310, 320. Column 330 may also be scrollable if the list of articles is long. READ SELECTED button 335 can be used to switch between all available articles and the selected articles. CLEAR SELECTED button 336 allows for the various selections to be cleared.

Additionally, the selected articles may be loaded for offline use. For example, the selected articles can be placed in memory that is available online or offline.

As a user selects an article using column 330, the article appears in columns 310, 320, thereby making selection of articles a one-step process. In this example, the user does not open or close separate tabs or open the article again in another application. In this example, the selection functionality is intuitively integrated with the content display, and articles are easily selected and read in a one-step technique.

GUI 300 operates with other intuitive and helpful features. For instance, GUI 300 includes column 310 for text portions of articles and column 320 for graphical elements of articles. Columns 310, 320 can be independently scrolled and are coordinated so as to automatically align the content of a particular article. The operation of a feature, such as that shown in columns 310, 320, is described in more detail in U.S. patent application Ser. No. ______ (Attorney Docket No. ZMBP.P0015US), filed concurrently herewith and entitled, “SYSTEMS, METHODS, AND COMPUTER PROGRAM PRODUCTS PROVIDING AN INTEGRATED USER INTERFACE FOR READING CONTENT,” which is incorporated by reference herein in its entirety.

In FIG. 3, GUI 300 is shown as part of a stand-alone application, such as may be downloaded and installed in a handheld device or tablet computer. In contrast to a general-purpose web browser, the application of FIG. 3 is specially adapted for reading articles with text and graphical images and may be less convenient for use in, e.g., playing games or watching videos that are not accompanied by text.

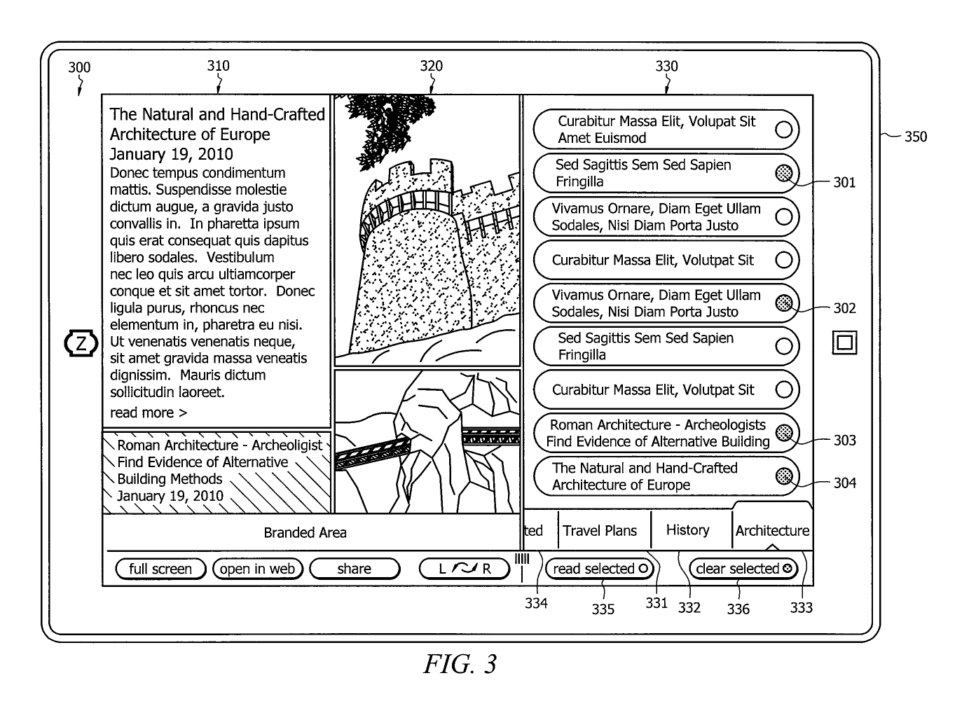

The selection feature shown in FIG. 3 is not limited to a stand-alone application, as in FIG. 3. FIG. 4 is an illustration of GUI 400, adapted according to one embodiment. In this example, GUI 400 is shown completely within the bounds of the content-viewing portion of general-purpose web browser 490 and thus, can be shown as a web page to a viewer. In this example, the entirety of GUI 400 is viewed content within the content-viewing portion of the browser. Nevertheless, the functionality of GUI 400 is the same as that of GUI 300 of FIG. 3. In some embodiments, the functionality and content of GUI 400 may be provided through use of known webpage creation resources, such as Hypertext markup Language (HTML), Java™, Flash™, and/or the like.

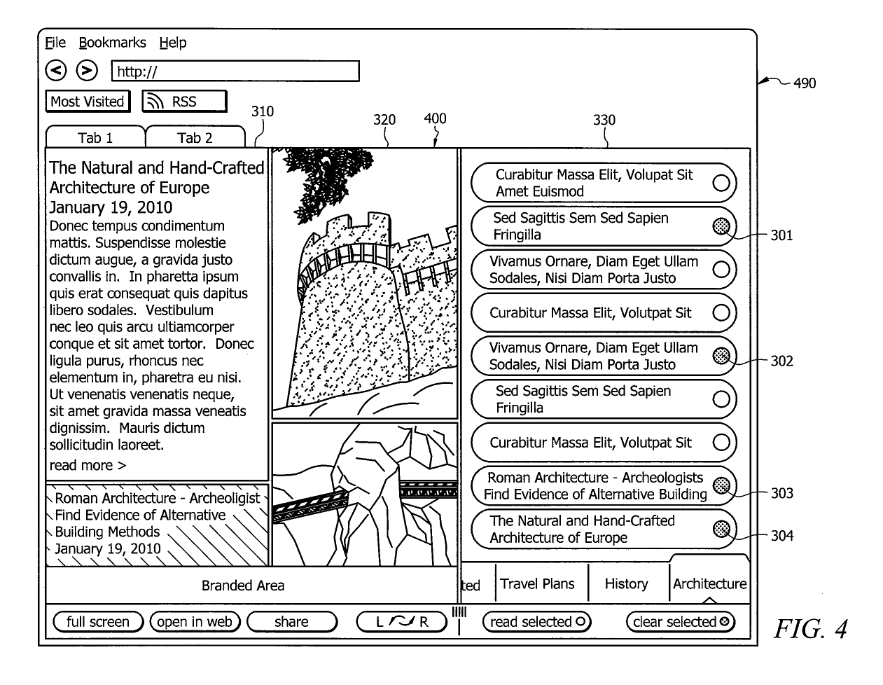

Furthermore, the scope of embodiments is not limited to pairing the article-selection technique with the double-column reading interface shown in FIGS. 3 and 4. FIG. 5 is a conceptual illustration of GUI 500 adapted according to an example embodiment. GUI 500 integrates selection portion 510 and reading portion 520 into a single view. Selection portion 510 includes list 515 of articles for selection, and when an article is selected, the article (or a representation of the article) appears in reading portion 520. In one example, when an article is selected, a thumbnail of the article appears in reading portion 520. In another example, when an article is selected, the article itself appears in reading portion 520. The article may be specially processed and displayed (such as with the columns 310, 320 of FIG. 3) or may simply be placed in reading portion 520 without more sophisticated processing.

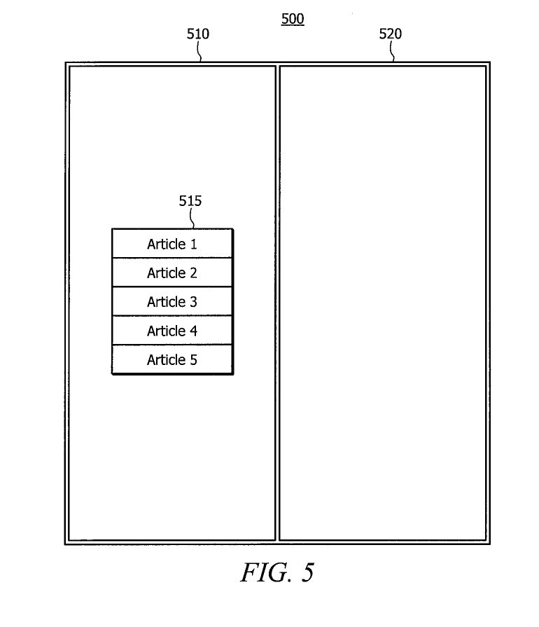

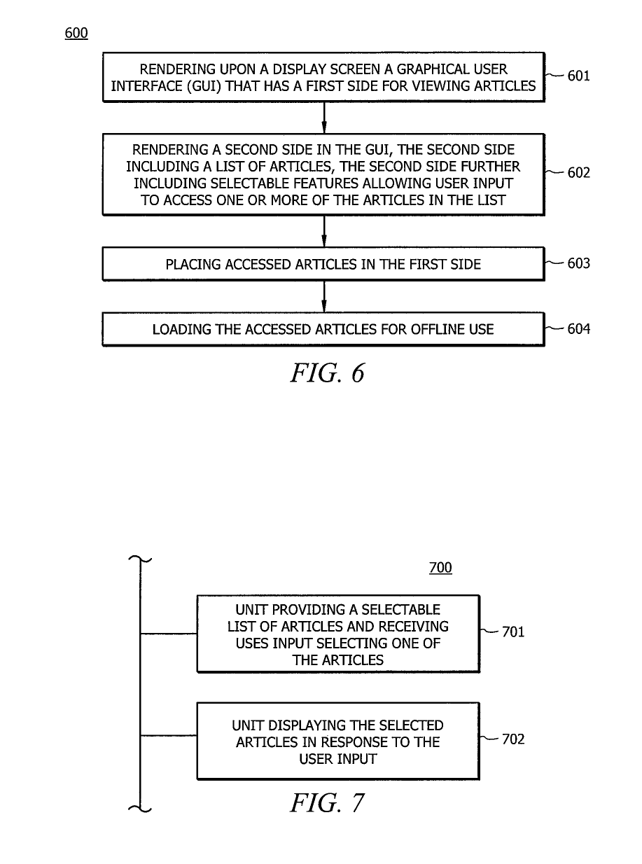

FIG. 6 is an illustration of exemplary method 600 adapted according to one embodiment of the invention. Method 600 may be performed, for example, by a processor-based device executing a program that instantiates the functional modules shown in FIG. 7.

In block 601, a Graphical User Interface (GUI) that has a first side for viewing articles is rendered upon a display screen. In block 602, a second side of the GUI is rendered. The second side includes a list of articles and selectable features allowing user input to access one or more of the articles in the list. In block 603, articles accessed using the selectable features are placed in the first side. In block 604, the accessed articles are loaded for offline use.

Various embodiments are not limited to the exact method shown in FIG. 6. Various embodiments may add, omit, rearrange, or modify actions. For instance, many embodiments will render first and second sides perceptibly simultaneously, so that actions of block 602 are performed with actions of block 601. Furthermore, the method 600 may be performed in the context of a general purpose web browser, where the GUI is entirely within the content-viewing portion of the browser, in the context of a stand-alone application different from a web browser, or in the context of a plug-in for another program, and/or the like.

Additionally, the term “article” is used herein in the examples above to refer to magazine or newspaper articles, though the term is not limited thereto. Articles may include other divisions of content, such as book chapters and/or the like.

FIG. 7 is an illustration of an exemplary system 700 adapted according to one embodiment of the invention. System 700 includes functional modules 701 and 702. The divisions of the functional modules is conceptual and exemplary, as the functions may be performed by a single functional unit or divided between two or more functional units different than those shown in FIG. 7.

Some embodiments include one or more advantages over other techniques. For instance, various embodiments provide a GUI that is more intuitive than previous attempts at allowing users to access multiple articles. Whereas previous techniques required at least two steps to save and retrieve some articles, various embodiments of the present invention provide a one-step technique from the user's point of view. Additionally, various embodiments may also provide a less cluttered alternative to opening up multiple tabs on a general-purpose web browser. Also, various embodiments may be more elegant and less navigation intensive than repeated, serial open-and-read actions.

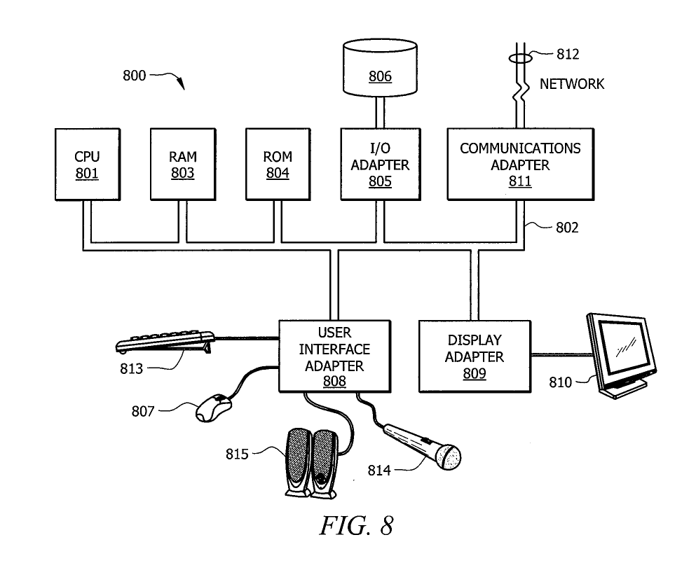

FIG. 8 illustrates an example computer system 800 adapted according to one embodiment of the present invention. That is, computer system 800 comprises an example system on which embodiments of the present invention may be implemented (such as processor-based device 350 of FIG. 3). Central processing unit (CPU) 801 is coupled to system bus 802. CPU 801 may be any general purpose or specialized purpose CPU. However, the present invention is not restricted by the architecture of CPU 801 as long as CPU 801 supports the inventive operations as described herein. CPU 801 may execute the various logical instructions according to embodiments of the present invention. For example, one or more CPUs, such as CPU 801, may execute machine-level instructions according to the exemplary operational flow described above in conjunction with FIG. 6.

Computer system 800 also preferably includes random access memory (RAM) 803, which may be SRAM, DRAM, SDRAM, or the like. In this example, computer system 800 uses RAM 803 to buffer 302 of FIG. 3. Computer system 800 preferably includes read-only memory (ROM) 804 which may be PROM, EPROM, EEPROM, or the like. RAM 803 and ROM 804 hold user and system data and programs, as is well known in the art.

Computer system 800 also preferably includes input/output (I/O) adapter 805, communications adapter 811, user interface adapter 808, and display adapter 809. I/O adapter 805, user interface adapter 808, and/or communications adapter 811 may, in certain embodiments, enable a user to interact with computer system 800 in order to input information, such as hand gestures (via a touchscreen or a pointing device) that indicate that one or more articles are selected.

I/O adapter 805 preferably connects to storage device(s) 806, such as one or more of hard drive, compact disc (CD) drive, floppy disk drive, tape drive, etc. to computer system 800. The storage devices may be utilized when RAM 803 is insufficient for the memory requirements associated with storing media data. Communications adapter 811 is preferably adapted to couple computer system 800 to network 812 (e.g., the Internet, a LAN, a cellular network, etc.). User interface adapter 808 couples user input devices, such as keyboard 813, pointing device 807, and microphone 814 and/or output devices, such as speaker(s) 815 to computer system 800. Display adapter 809 is driven by CPU 801 to control the display on display device 810 to, for example, display the articles.

While the above examples are provided in the context of tablet computers with touchscreens, the scope of embodiments is not so limited. For instance, some embodiments may be adapted for use with handheld devices, laptop computers, desktop computers, workstations, and/or other process-based devices with a GUI. Additionally, some embodiments can be used with devices that do not have a touchscreen but, instead, rely on another manner of screen navigation, such as pointing, hotkeys, and the like. Moreover, embodiments of the present invention are not limited to general purpose computers and may be implemented on other types of processors, such as application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product having a computer readable medium tangibly recording computer program logic, the computer program product comprising:
code to provide a web access program different from a general-purpose web browser, the web access program including:
code to render upon a display screen a Graphical User Interface (GUI) that has a first side for viewing content;
code to render a second side in the GUI, the second side including a list of articles, the second side further including a plurality of selectable features allowing user input to access one or more of the articles; and
code to place accessed articles in the first side.

2. The computer program product of claim 1 in which the selectable features include buttons with names of the articles in the list.

3. The computer program product of claim 1 in which the web access program comprises a web browser specially adapted for viewing articles.

4. The computer program product of claim 1 in which the web access program comprises a stand-alone application for at least one of a tablet computer and a handheld device.

5. The computer-program product of claim 1 in which the GUI is touchscreen operated.

6. A computer-executed method for accessing web-based content upon a display screen, the method comprising:
launching a web content access program that does not comprise a general-purpose web browser;
rendering within the web content access program a Graphical User Interface (GUI) that has a first portion with a list of articles and functions for selecting the articles in the list and a second portion including selected ones of the articles; and
receiving user input in the first portion for selecting ones of the articles.

7. The method of claim 6 performed by a tablet computer.

8. The method of claim 6 performed by at least one of a laptop computer, a desktop computer, and a handheld device.

9. The method of claim 6 further comprising:
causing the selected ones of the articles to appear in the second portion responsive to the user input.

10. The method of claim 6 further comprising:
saving the selected ones of the articles for offline use.

11. A system providing a Graphical User Interface (GUI) within a general-purpose web browser rendered upon a display screen, the system including:
a first functional unit providing a selectable list of articles and receiving user input selecting ones of the articles; and
a second functional unit displaying the selected ones of the articles upon the display screen responsive to the user input, the displayed selected ones of the articles and the selectable list of articles being rendered entirely within a content-viewing portion of the general-purpose web browser.

12. The system of claim 11 comprising a processor executing code to provide the first and second functional units.

13. The system of claim 12 in which the processor is included in a computing device with a touchscreen to receive the user input.

14. The system of claim 11 in which the selectable list of articles and the selected ones of the articles are displayed side-by-side.

15. A computer program product having a computer readable medium tangibly recording computer program logic, the computer program product comprising:
code to render a Graphical User Interface (GUI) entirely within a content-viewing portion of a general-purpose web browser, the GUI having a first side for article content;
code to render a second side in the GUI, the second side including a list of articles, the second side further including a plurality of selectable features allowing user input to access one or more of the articles; and
code to place accessed articles in the first side.

16. The computer program product of claim 15 in which the GUI comprises a plug-in for the general-purpose web browser.

17. The computer-program product of claim 15 in which the GUI is touchscreen operated.
